(19) United States
(12) Patent Application Publication
(10) Pub. No.: US 2024/0315269 A1
(43) Pub. Date: Sep. 26, 2024

(54) PREPARATION METHOD OF COFFEE CHERRY TEA

(71) Applicants: Institute of Tropical and Subtropical Cash Crops, Yunnan Academy of Agricultural Sciences, Baoshan (CN); Spice and Beverage Research Institute, Chinese Academy of Tropical Agricultural Sciences, Wanning (CN); Yunnan Jinglan Hot Work Technology Co., Ltd., Baoshan (CN)

(72) Inventors: Faguang Hu, Baoshan (CN); Xiaofei Bi, Baoshan (CN); Xingfei Fu, Baoshan (CN); Wenjiang Dong, Wanning (CN); Xinping Luo, Baoshan (CN); Yanan Li, Baoshan (CN); YaQi Li, Baoshan (CN); Dexin Liu, Baoshan (CN); Yang Yang, Baoshan (CN); Guiping Li, Baoshan (CN); Wei Huang, Baoshan (CN); Rongsuo Hu, Wanning (CN)

(21) Appl. No.: 18/123,674

(22) Filed: Mar. 20, 2023

(51) Int. Cl. A23F 3/08; A23F 3/14; A23F 3/16

(52) U.S. Cl. CPC A23F 3/08; A23F 3/14; A23F 3/166

(57) ABSTRACT

A preparation method of coffee cherry tea is provided, including following steps: taking ripe and full fresh coffee berries, washing, draining and peeling the fresh coffee berries to obtain coffee peels; drying the coffee peels immediately until a moisture content is in a range of 20% to 30% to obtain dried coffee peels; fermenting the dried coffee peels for a range of 2 days to 3 days to obtain fermentation products; and baking the fermentation products for a range of 3 minutes to 4 minutes under a temperature in a range of 100 Celsius degree (° C.) to 180° C. to obtain the coffee cherry tea. The coffee cherry tea obtained by the preparation method has a mellow and sweet taste, which effectively solves the problem of sour and astringent taste of the existing coffee cherry tea.

### TECHNICAL FIELD

The disclosure relates to the field of food processing technologies, in particular to a preparation method of coffee cherry tea.

### BACKGROUND

Coffee is perennial evergreen shrubs or small trees of the genus Coffea of the family Rubiaceae, which is native to tropical rainforests in north-central Africa. Coffee is known as one of the world's three largest beverage crops alongside tea and cocoa and is the most consumed non-alcoholic beverage in the world today.

At present, wet processing method (including fresh coffee berries taking, peeling, fermentation degumming, washing, soaking, and air-drying) is widely used in the initial processing and production of coffee to obtain coffee beans. However, a large number of coffee peels produced in the processing are generally discarded or returned to the field as fertilizer, resulting in serious environmental pollution.

The coffee peels are rich in caffeine, anthocyanin, dietary fiber, crude protein and a variety of minerals and other active ingredients. Recently, the coffee peels are gradually processed to obtain coffee cherry tea (also known as cascara, from the Spanish cáscara, meaning “husk”) to sell. At present, there are two processing methods of the coffee cherry tea, one is sun-drying fresh peels, the processing process is specifically sun-drying the fresh coffee berries, then taking off outer peels, and baking the outer peels to obtain the coffee cherry tea; the other is degumming the peels, the processing process is specifically using fresh and ripe coffee berries to first peel the outer peels, and then obtaining the coffee cherry tea by directly sun-drying and baking the peeled outer peels. Although the taste of the coffee cherry tea prepared by the above two methods is sweet and sour, it has a slightly raw green taste. In addition, the prepared coffee cherry tea cannot release its nutrients, and is slightly poor in health care effects. Therefore, the problem needed to be solved at present is to enrich and improve the taste of the coffee cherry tea.

### SUMMARY

In response to shortcomings of the related art, the disclosure provides a preparation method of coffee cherry tea. The preparation method described in the disclosure solves the problem of sour and astringent taste of the coffee cherry tea in the related art, and the prepared coffee cherry tea is in good health care effects.

In order to achieve the above purposes, the disclosure provides the preparation method of coffee cherry tea, including:
step 1, taking fresh coffee berries, washing, draining and peeling the fresh coffee berries to obtain coffee peels;
step 2, drying the coffee peels until a moisture content is in a range of 20% to 30% to obtain dried coffee peels;
step 3, fermenting the dried coffee peels for a range of 2 days to 3 days to obtain fermentation products; and
step 4, baking the fermentation products for a range of 3 minutes (min) to 4 min under a temperature in a range of 100 Celsius degree (° C.) to 180° C. to obtain the coffee cherry tea.

In an illustrated embodiment of the disclosure, a number of times for the washing in the step 1 is in a range of 3 times to 4 times.

In an illustrated embodiment of the disclosure, a temperature of the drying in the step 2 is in a range of 40° C. to 50° C., and a duration of the drying in the step 2 is in a range of 4 hours (h) to 6 h.

In an illustrated embodiment of the disclosure, the fermenting in the step 3 specifically includes: spraying coffee peel crude extracts on the dried coffee peels and then drying at a temperature in a range of 30° C. to 40° C., repeating the spraying and the drying for a range of 3 times to 4 times, and fermenting for a range of 2 days to 3 days.

In an illustrated embodiment of the disclosure, a temperature of the fermenting in the step 3 is in a range of 25° C. to 30° C., a relative humidity of the fermenting in the step 3 is in a range of 70% to 80%, and a potential of hydrogen (referred to pH value) of the fermenting in the step 3 is in a range of 4 to 7.

In an illustrated embodiment of the disclosure, the coffee peel crude extracts are prepared by: adding the coffee peels to a microwave counter-current extractor to obtain microwave treated products, while adding a compound enzyme consisting of cellulose:pectinase:pancreatin in a mass ratio of 5-7:4:3 to extract for a range of 30 min to 60 min to discharge by the microwave counter-current extractor, thereby to obtain the coffee peel crude extracts.

In an illustrated embodiment of the disclosure, an enzyme activity of the cellulase is 10000 active units per gram (U/g), and an addition amount of the cellulase is in a range of 0.05 g to 0.1 g relative to per gram of the microwave treated products; an enzyme activity of the pectinase is 10000 U/g, and an addition amount of the pectinase is in a range of 0.05 g to 0.1 g relative to per gram of the microwave treated products; and an enzyme activity of the pancreatin is 5000 U/g, and an addition amount of the pancreatin is in a range of 0.05 g to 0.1 g relative to per gram of the microwave treated products.

In an illustrated embodiment of the disclosure, a spray amount of the coffee peel crude extracts (also referred to a hydrolytic enzyme solution) is in a range of 20% to 40% of a weight of the dried coffee peels.

The beneficial effects of the disclosure are as follows. The disclosure selects the fresh coffee berries to wash, drain for peeling, drying, fermenting and baking to obtain the coffee cherry tea. The disclosure first dries the coffee peels to certain moisture content before the fermenting to control the moisture content of the dried coffee peels, which is conducive to reducing the moldy peels caused by wet fermentation due to the large amount of water during the conventional fermentation. Furthermore, the fermented coffee cherry tea has a better flavor, is more conducive to the release of nutrients in the coffee peels, and reduces the original sour and astringent taste in the coffee peels. The disclosure bakes the fermentation products, further reducing the sour and astringent taste in the coffee peels and improving the aroma of the coffee peels. In addition, the coffee peels after high-temperature bake are more conducive to preservation.

### DETAILED DESCRIPTION OF EMBODIMENTS

Various exemplary embodiments of the disclosure are now described in detail, and the detailed descriptions should not be construed as a limitation of the disclosure, but should be understood as a more detailed description of certain aspects, features and embodiments of the disclosure.

A preparation method of coffee cherry tea is provided, which includes following steps.
Step 1, ripe and full fresh coffee berries are taken for washing, draining and peeling to obtain coffee peels.
Step 2, the coffee peels are dried immediately until a moisture content is in a range of 20% to 30% to obtain dried coffee peels.
Step 3, the dried coffee peels are fermented for a range of 2 days to 3 days to obtain fermentation products.
Step 4, the fermentation products are baked for a range of 3 minutes (min) to 4 min at a temperature in a range of 100 Celsius degree (° C.) to 180° C. to obtain the coffee cherry tea.

The disclosure selects the ripe and full fresh coffee berries for washing and draining, and then the coffee berries are peeled to obtain the coffee peels. The coffee berries must be fully ripe, full, and free of disease, insects and mold. Unripe coffee berries, diseased coffee berries, overripe coffee berries, deflated coffee berries, moldy coffee berries and other poor quality coffee berries must be totally removed. The washing times is in a range of 3 times to 4 times, which is used for washing and flotation to facilitate removing dust, branches, floating coffee berries (also referred to the deflated coffee berries) and sinking immature coffee berries. Washing the coffee berries for a range of three times to four times until the water becomes clear can reduce the admixture of impurities and avoid affecting the fermentation, which finally affects the flavor of the coffee cherry tea.

The obtained coffee peels are immediately dried until the moisture content is in the range of 20% to 30% to obtain the dried coffee peels. In the disclosure, the coffee peels should be dried immediately; otherwise the coffee peels will naturally ferment and then become acidic due to high moisture content thus affecting the taste and texture. A temperature of the drying in the step 2 is in a range of 40° C. to 50° C., and a duration of the drying in the step 2 is in a range of 4 hours (h) to 6 h. The disclosure controls the moisture content after the drying to avoid moldy peels caused by wet fermentation due to the excessive moisture content.

Coffee peel crude extracts are sprayed on the dried coffee peels, followed by drying at a temperature in a range of 30° C. to 40° C. Further, the spraying and drying operation is repeated for a range of 3 times to 4 times, followed by fermenting for a range of for 2 days to 3 days. The disclosure sprays the coffee peel crude extracts on the outer surface of the dried coffee peels to enhance the flavor of the coffee cherry tea and provide the raw materials for the subsequent fermenting so that the fermenting can be carried out to the maximum extent.

In the disclosure, the coffee peel crude extracts are prepared by: adding the coffee peels to a microwave counter-current extractor to obtain microwave treated products, while adding a compound enzyme consisting of cellulase:pectinase:pancreatin in a mass ratio of 5-7:4:3 to extract for a range of 30 min to 60 min to discharge by the microwave counter-current extractor, thereby to obtain the coffee peel crude extracts. The addition of the pancreatin in the disclosure can completely degrade the proteins, fats and starches in the raw materials into small molecules to increase the probability of cellulose and pectin coming into contact with the corresponding enzymes, thereby to increase the degradation rates. An enzyme activity of the cellulase is 10000 active units per gram (U/g) (referred to an unit of measurement of the enzyme activity, and particularly one enzyme activity unit referring to the amount of enzyme that can convert 1 micromolar of substrate in 1 minute under specific conditions or the amount of enzyme that converts 1 micromolar of the substrate group of interest), and an addition amount of the cellulase is in a range of 0.05 g to 0.1 g relative to per gram of the microwave treated products; an enzyme activity of the pectinase is 10000 U/g, and an addition amount of the pectinase is in a range of 0.05 g to 0.1 g relative to per gram of the microwave treated products; and an enzyme activity of the pancreatin is 5000 U/g, and an addition amount of the pancreatin is in a range of 0.05 g to 0.1 g relative to per gram of the microwave treated products. In an illustrated embodiment of the disclosure, a spray amount of the coffee peel crude extracts (also referred to a hydrolytic enzyme solution) is in a range of 20% to 40% of a weight of the dried coffee peels; a temperature of the fermenting in the step 3 is in a range of 25° C. to 30° C., a relative humidity of the fermenting in the step 3 is in a range of 70% to 80%, and a potential of hydrogen (referred to pH value) of the fermenting in the step 3 is in a range of 4 to 7.

The fermentation products are baked for a range of 3 min to 4 min under a temperature in a range of 100° C. to 180° C. to finally obtain the coffee cherry tea.

In order to better understand the disclosure, the following further describes the disclosure in conjunction with embodiments, but the disclosure is not limited to the following embodiments.

### Embodiment 1

The coffee peel crude extracts are prepared according to the following steps.

The coffee peels are added to the microwave counter-current extractor, while the compound enzyme consisting of cellulase:pectinase:pancreatin in a mass ratio of 5:4:3 to extract for 50 min, and the extractor is discharged to obtain the coffee peel crude extracts. The enzyme activity of the cellulase is 10000 U/g, and the addition amount of the cellulase is 0.06 g relative to per gram of the microwave treated products; the enzyme activity of the pectinase is 10000 U/g, and the addition amount of the pectinase is 0.06 g relative to per gram of the microwave treated products; and the enzyme activity of the pancreatin is 5000 U/g, and the addition amount of the pancreatin is 0.07 g relative to per gram of the microwave treated products.

### Embodiment 2

A preparation method of coffee cherry tea is performed according to the following steps:
step 1, taking the ripe and full fresh coffee berries, washing 4 times, draining and peeling the fresh coffee berries to obtain coffee peels;
step 2, drying the coffee peels by a hot-wind machine until the moisture content is 25% to obtain dried coffee peels;
step 3, spraying the coffee peel crude extracts uniformly on the surface of the dried coffee peels in the amount of 30% of the weight of the dried coffee peels followed by drying at the temperature of 35° C., repeating the spraying and drying 3 times and fermenting at the temperature of 25° C., relative humidity of 75% and pH of 5 for 2 days to obtain the fermentation products; and step 4, baking the fermentation products for 4 min at the temperature of 150° C. to finally obtain the coffee cherry tea.

The coffee peel crude extracts are provided by the embodiment 1.

### Embodiment 3

A preparation method of coffee cherry tea is performed according to the following steps:
step 1, taking the ripe and full fresh coffee berries, washing 4 times, draining and peeling the fresh coffee berries to obtain coffee peels;
step 2, drying the coffee peels by a hot-wind machine until the moisture content is 20% to obtain dried coffee peels;
step 3, spraying the coffee peel crude extracts uniformly on the surface of the dried coffee peels in the amount of 20% of the weight of the dried coffee peels followed by drying at the temperature of 40° C., repeating the spraying and drying 3 times and fermenting at the temperature of 25° C., relative humidity of 70% and pH of 4.5 for 3 days to obtain the fermentation products; and
step 4, baking the fermentation products for 4 min at the temperature of 140° C. to finally obtain the coffee cherry tea.

The coffee peel crude extracts are provided by the embodiment 1.

### Embodiment 4

A preparation method of coffee cherry tea is performed according to the following steps:
step 1, taking the ripe and full fresh coffee berries, washing 4 times, draining and peeling the fresh coffee berries to obtain coffee peels;
step 2, drying the coffee peels by a hot-wind machine until the moisture content is 30% to obtain dried coffee peels;
step 3, spraying the coffee peel crude extracts uniformly on the surface of the dried coffee peels in the amount of 40% of the weight of the dried coffee peels followed by drying at the temperature of 40° C., repeating the spraying and drying 4 times and fermenting at the temperature of 30° C., relative humidity of 80% and pH of 6 for 2 days to obtain the fermentation products; and step 4, baking the fermentation products for 3 min at the temperature of 170° C. to finally obtain the coffee cherry tea.

The coffee peel crude extracts are provided by the embodiment 1.

### Contrast Embodiment 1

A difference between the embodiment 2 and the contrast embodiment 1 is that the coffee peels in the step 2 are not operated the drying.

### Contrast Embodiment 2

A difference between the embodiment 2 and the contrast embodiment 2 is that the moisture content of the dried coffee peels in the step 2 is 10%.

### Contrast Embodiment 3

A difference between the embodiment 2 and the contrast embodiment 3 is that the temperature of the baking in the step 4 is 70° C.

The coffee cherry tea prepared by the embodiments 2-4 and the contrast embodiments 1-3 are compared by sensory evaluation. The coffee cherry tea prepared by the embodiments 2-4 have no sourness and astringency and are tasted mellow and sweet. However, a small amount of the coffee peels in the contrast embodiment 1 are moldy during the fermentation, and the coffee cherry tea prepared by the contrast embodiments 2-3 all show varying degrees of sourness and astringency.

The above described embodiments only express the illustrated embodiments of the disclosure, whose descriptions are more specific and detailed. However, the above described embodiments are not understood as a limitation of a scope of protection of the disclosure. It should be noted that, for those skilled in the related art, a number of variations and improvements can be made without departing from the conception of the disclosure, so that the variations and improvements all fall within the scope of protection of the disclosure. Therefore, the scope of protection of the disclosure shall be subject to the appended claims.

What is claimed is:

1. A preparation method of coffee cherry tea, comprising:
step 1, taking fresh coffee berries, washing, draining and peeling the fresh coffee berries to obtain coffee peels;
step 2, drying the coffee peels until a moisture content is in a range of 20% to 30% to obtain dried coffee peels;
step 3, fermenting the dried coffee peels for a range of 2 days to 3 days to obtain fermentation products; and
step 4, baking the fermentation products for a range of 3 minutes (min) to 4 min under a temperature in a range of 100 Celsius degree (° C.) to 180° C. to obtain the coffee cherry tea.

2. The preparation method of coffee cherry tea according to claim 1, wherein a number of times for the washing in the step 1 is in a range of 3 times to 4 times.

3. The preparation method of coffee cherry tea according to claim 1, wherein a temperature of the drying in the step 2 is in a range of 40° C. to 50° C., and a duration of the drying in the step 2 is in a range of 4 hours (h) to 6 h.

4. The preparation method of coffee cherry tea according to claim 1, wherein the fermenting in the step 3 specifically comprises:
spraying coffee peel crude extracts on the dried coffee peels and then drying at a temperature in a range of 30° C. to 40° C., repeating the spraying and the drying for a range of 3 times to 4 times, and fermenting for a range of 2 days to 3 days.

5. The preparation method of coffee cherry tea according to claim 1, wherein a temperature of the fermenting in the step 3 is in a range of 25° C. to 30° C., a relative humidity of the fermenting in the step 3 is in a range of 70% to 80%, and a potential of hydrogen (pH value) of the fermenting in the step 3 is in a range of 4 to 7.

6. The preparation method of coffee cherry tea according to claim 4, wherein the coffee peel crude extracts are prepared by:
adding the coffee peels to a microwave counter-current extractor to obtain microwave treated products, while adding a compound enzyme consisting of cellulose: pectinase:pancreatin in a mass ratio of 5-7:4:3 to extract for a range of 30 min to 60 min to discharge by the microwave counter-current extractor, thereby to obtain the coffee peel crude extracts.

7. The preparation method of coffee cherry tea according to claim 6, wherein an enzyme activity of the cellulase is 10000 active units per gram (U/g), and an addition amount of the cellulase is in a range of 0.05 g to 0.1 g relative to per gram of the microwave treated products; an enzyme activity of the pectinase is 10000 U/g, and an addition amount of the pectinase is in a range of 0.05 g to 0.1 g relative to per gram of the microwave treated products; and an enzyme activity of the pancreatin is 5000 U/g, and an addition amount of the pancreatin is in a range of 0.05 g to 0.1 g relative to per gram of the microwave treated products.

8. The preparation method of coffee cherry tea according to claim 4, wherein a spray amount of the coffee peel crude extracts as a hydrolytic enzyme solution is in a range of 20% to 40% of a weight of the dried coffee peels.
